(19) United States
(12) Patent Application Publication
(10) Pub. No.: US 2002/0135146 A1
(43) Pub. Date: Sep. 26, 2002

(54) Inclination prevention structure of child wheeled vehicle

(76) Inventor: Tsai-Jao Hsing, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/811,607

(22) Filed: Mar. 20, 2001

(51) Int. Cl. B62H 1/10; A63B 69/16

(52) U.S. Cl. 280/87.021; 280/293; 280/755

(57) ABSTRACT

The present invention relates to an inclination prevention structure of a child wheeled vehicle including a rotation shaft having one end extended through the bottom of the vehicle body and secured with one end of a swing arm which can be rotated with the rotation shaft. The other end of the swing arm has two sides respectively pivoted with a wheel, thereby forming a swing wheel set. An inclination prevention bracket mounted between the vehicle body and the swing arm has one end combined with the rotation shaft, and can swing with the swing arm synchronously. The inclination prevention bracket is extended toward a direction directed opposite to the wheel of the swing wheel set, is bent downward, and is formed with an abutting portion adjacent to the ground. In such a manner, the child wheeled vehicle can obtain a better support during turning around, thereby enhancing the safety of use.

### BACKGROUND OF THE INVENTION

1. Field of the Invention

The present invention relates to an inclination prevention structure of a child wheeled vehicle, and more particularly to an inclination prevention structure of a child wheeled vehicle for balancing the child wheeled vehicle during turning around.

2. Description of the Related Prior Art

A conventional child wheeled vehicle in accordance with the prior art shown in FIG. 6 comprises a vehicle body 10, having a rear end pivoted with two rear wheels 12, and a front end provided with a rotation shaft 40. The rotation shaft 40 has an upper end secured with a handle 400, and a lower end secured with a swing arm set 5 including a swing arm 50 pivoted with two wheels 51. The rider may rotate the handle 400 to rotate the rotation shaft 40 to swing the swing arm 50 so that the child wheeled vehicle can travel forward in a swinging manner.

However, when the wheels 51 of the swing arm set 5 deviate to one side of the vehicle body 10, the other side of the vehicle body 10 is suspended without any support, so that the child wheeled vehicle is not balanced. Thus, the vehicle body 10 is inclined toward the other side without support to touch the ground, so that the rider easily falls down, thereby causing danger to the rider.

### SUMMARY OF THE INVENTION

The present invention has arisen to mitigate and/or obviate the disadvantage of the conventional child wheeled vehicle.

The primary objective of the present invention is to provide an inclination prevention structure of a child wheeled vehicle that can efficiently prevent the vehicle body from being inclined during travel, thereby preventing the rider from falling.

In accordance with the present invention, there is provided an inclination prevention structure of a child wheeled vehicle comprising a vehicle body provided with a rotation shaft at a predetermined position thereof, the rotation shaft having one end extended through a bottom of the vehicle body and secured with a first end of a swing arm which can be rotated with the rotation shaft, a second end of the swing arm having two sides respectively pivoted with a wheel, thereby forming a swing wheel set, wherein, the one end of the rotation shaft extended through the bottom of the vehicle body is secured with an inclination prevention bracket which can swing with the swing arm synchronously, the inclination prevention bracket is extended toward a direction directed opposite to the wheel of the swing wheel set, and is bent downward, and is formed with an abutting portion located at a position adjacent to the ground.

In accordance with one aspect of the present invention, the inclination prevention bracket is an inverted L-shaped plate.

In accordance with another aspect of the present invention, the inclination prevention bracket defines a through slot for securing the rotation shaft so as to rotate with the swing arm synchronously.

In accordance with a further aspect of the present invention, the abutting portion of the inclination prevention bracket is provided with two parallel ear plates, and a roller is pivoted between the two ear plates.

In accordance with a further aspect of the present invention, the abutting portion of the inclination prevention bracket is provided with a swing rack, and a roller rotatably mounted on the swing rack and rested on the ground.

In accordance with a further aspect of the present invention, the abutting portion of the inclination prevention bracket is formed with an arc-shaped face which can be rested on the ground.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an inclination prevention structure of a child wheeled vehicle in accordance with a first embodiment of the present invention;

FIG. 2 is a front plan cross-sectional assembly view of the inclination prevention structure of a child wheeled vehicle as shown in FIG. 1;

FIG. 3 is a schematic view of the inclination prevention structure of a child wheeled vehicle as shown in FIG. 2;

FIG. 4 is a perspective view of an inclination prevention bracket of an inclination prevention structure of a child wheeled vehicle in accordance with a second embodiment of the present invention;

FIG. 5 is a perspective view of an inclination prevention bracket of an inclination prevention structure of a child wheeled vehicle in accordance with a third embodiment of the present invention; and

FIG. 6 is a front schematic view of a conventional child wheeled vehicle in accordance with the prior art.

### DETAILED DESCRIPTION OF THE INVENTION

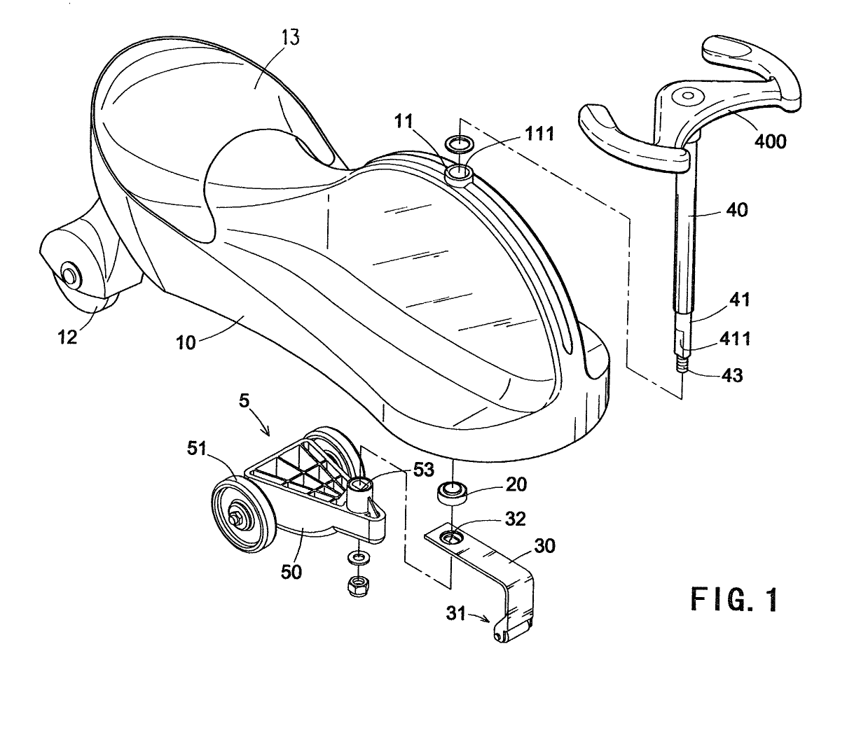

Referring to the drawings and initially to FIGS. 1-3, an inclination prevention structure of a child wheeled vehicle in accordance with a first embodiment of the present invention comprises a vehicle body 10, a rotation shaft 40, a swing wheel set 5, and an inclination prevention bracket 30.

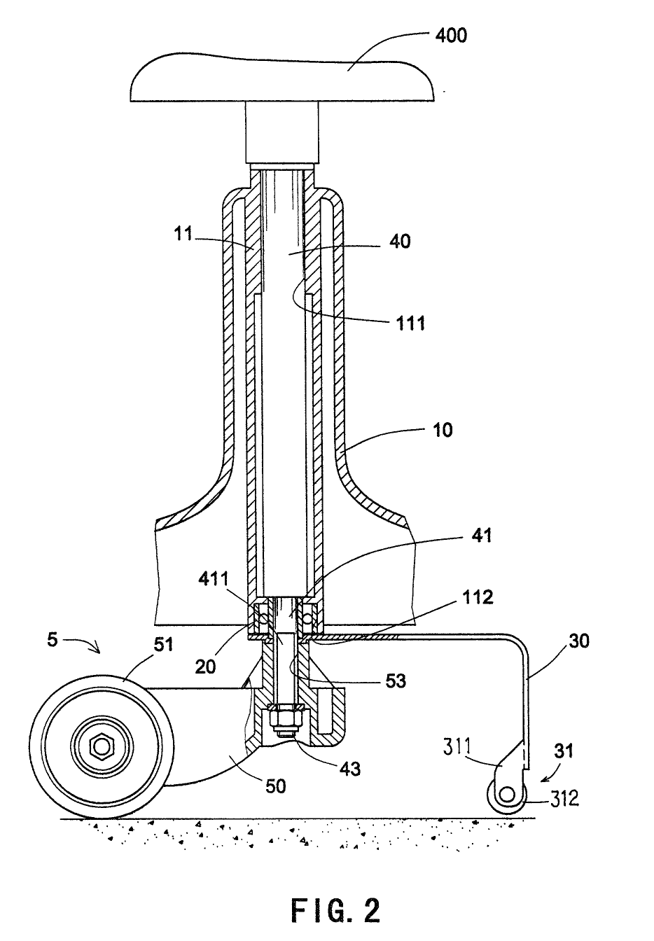

The vehicle body 10 has a rear end having two sides each pivoted with a rear wheel 12. The top face of the rear end of the vehicle body 10 is provided with a seat 13 for allowing riding of the rider. The front end of the vehicle body 10 provided with a tube 11 extended from the top to the bottom of the vehicle body 10 as shown in FIG. 2. The tube II defines a through hole 111 which has a bottom defining an insertion recess 112 into which a bearing 20 is inserted.

As shown in FIGS. 1 and 2, the rotation shaft 40 is extended through the tube 11 of the vehicle body 10, and has an upper end secured with a handle 400, and a lower end formed with a first axle portion 41 having a reduced diameter. The first axle portion 41 is extended through the bearing 20, and is formed with a flattened combination portion 411, and a screw portion 43 each extended outward from the bearing 20.

As shown in FIGS. 1 and 2, the inclination prevention bracket 30 is an inverted L-shaped plate, and has one end defining a through slot 32 for securing the combination portion 411 of the rotation shaft 40 so as to rotate with the swing arm 50 synchronously. The inclination prevention bracket 30 is extended toward a direction directed opposite to the wheel 51 of the swing wheel set 5, and is bent downward, and is formed with an abutting portion 31 located at a position adjacent to the ground. The abutting portion 31 of the inclination prevention bracket 30 is provided with two parallel ear plates 311. A roller 312 is pivoted between the two ear plates 311, and is spaced from the ground with a distance as shown in FIG. 2.

As shown in FIG. 2, the swing wheel set 5 is mounted on the combination portion 411 of the first axle portion 41 of the rotation shaft 40, and is located under the inclination prevention bracket 30. The swing arm set 5 includes a swing arm 50, and two wheels 51. The swing arm 50 can be rotated with the rotation shaft 40 and has one end defining a through hole 53 for securing the combination portion 411 of the rotation shaft 40. The other end of the swing arm 50 has two sides respectively pivoted with a wheel 51. A nut is screwed on the screw portion 43 of the rotation shaft 40, thereby positioning the swing arm 5 and the inclination prevention bracket 30 on the rotation shaft 40, whereby the swing arm 5 and the inclination prevention bracket 30 can swing with rotation of the rotation shaft 40 driven by the handle 400, so that the child wheeled vehicle can travel forward in a swing manner.

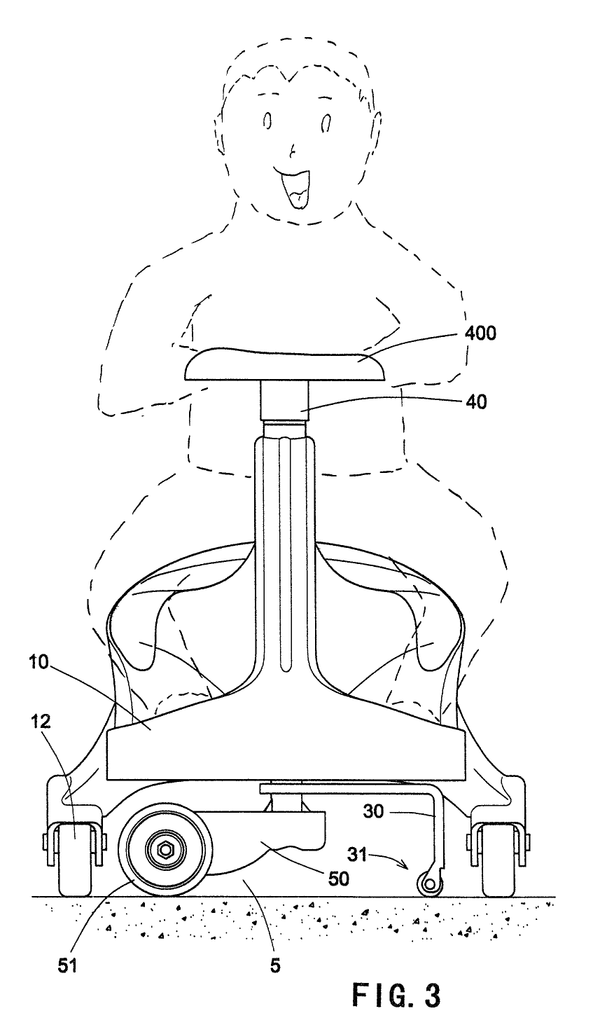

The inclination prevention bracket 30 is located opposite to the swing arm 50 of the swing arm set 5, and is formed with an abutting portion 31 adjacent to the ground. The abutting portion 31 is spaced from the ground with a determined distance. Thus, when the child wheeled vehicle travels forward in a swinging manner, the abutting portion 31 of the inclination prevention bracket 30 is not in contact with the ground as shown in FIG. 2, so that the abutting portion 31 of the inclination prevention bracket 30 will not hinder movement of the child wheeled vehicle. When the child wheeled vehicle is turned around as shown in FIG. 2, the wheels 51 of the swing arm set 5 will deviate at one side of the vehicle body 10, while the inclination prevention bracket 30 is moved with rotation of the rotation shaft 40 to swing to the other side of the vehicle body 10 opposite to the swing arm set 5 as shown in FIG. 3. Meanwhile, if the vehicle body 10 is slightly inclined, the abutting portion 31 of the inclination prevention bracket 30 is rested on the ground to support the other side of the vehicle body 10, so that the two sides of the vehicle body 10 can obtain a better and rigid support, thereby efficiently preventing inclination of the vehicle body 10 when the child wheel vehicle turns around, and thereby preventing the rider from falling, so as to ensure the rider's safety.

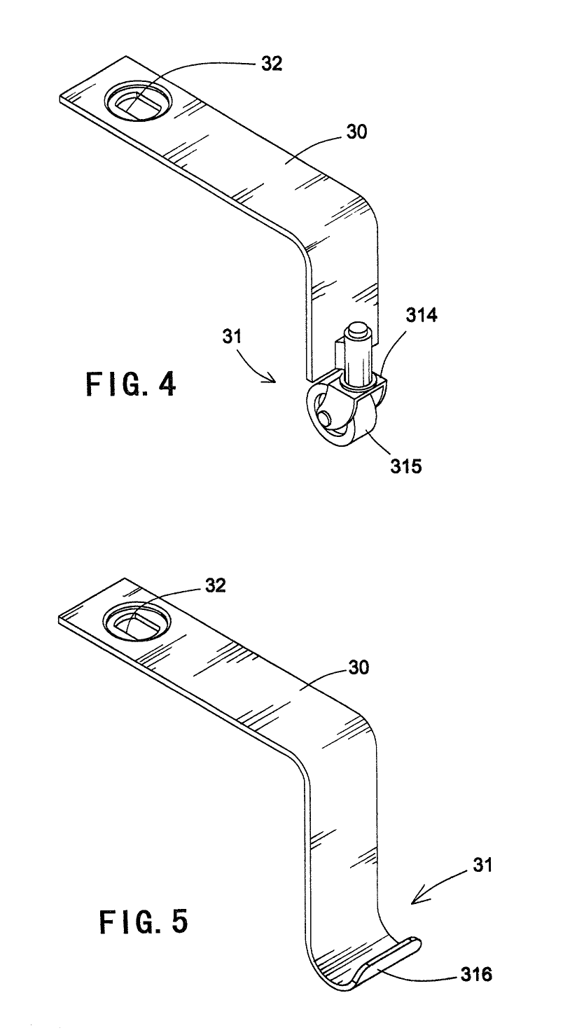

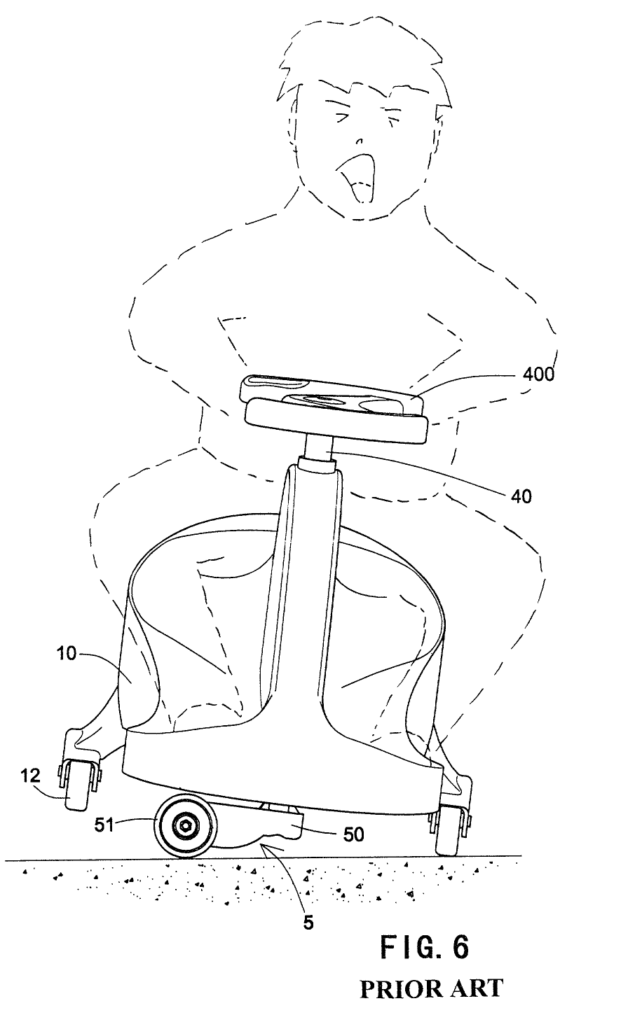

Referring to FIG. 4, in accordance with a second embodiment of the present invention, the abutting portion 31 of the inclination prevention bracket 30 is provided with a swing rack 314, and a roller 315 rotatably mounted on the swing rack 314 and rested on the ground.

Referring to FIG. 5, in accordance with a third embodiment of the present invention, the abutting portion 31 of the inclination prevention bracket 30 is formed with an arc-shaped face 316 which can be rested on the ground.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. An inclination prevention structure of a child wheeled vehicle comprising a vehicle body (10) provided with a rotation shaft (40) at a predetermined position thereof, said rotation shaft (40) having one end extended through a bottom of said vehicle body (10) and secured with a first end of a swing arm (50) which can be rotated with said rotation shaft (40), a second end of said swing arm (50) having two sides respectively pivoted with a wheel (51), thereby forming a swing wheel set (5), wherein,
said one end of said rotation shaft (40) extended through said bottom of said vehicle body (10) is secured with an inclination prevention bracket (30) which can swing with said swing arm (50) synchronously, said inclination prevention bracket (30) is extended toward a direction directed opposite to said wheel (51) of said swing wheel set (5), and is bent downward, and is formed with an abutting portion (31) located at a position adjacent to the ground.

2. The inclination prevention structure of a child wheeled vehicle in accordance with claim 1, wherein said inclination prevention bracket (30) is an inverted L-shaped plate.

3. The inclination prevention structure of a child wheeled vehicle in accordance with claim 1, wherein said inclination prevention bracket (30) defines a through slot (32) for securing said rotation shaft (40) so as to rotate with said swing arm (50) synchronously.

4. The inclination prevention structure of a child wheeled vehicle in accordance with claim 1, wherein said abutting portion (31) of said inclination prevention bracket (30) is provided with two parallel ear plates (311), and a roller (312) is pivoted between said two ear plates (311).

5. The inclination prevention structure of a child wheeled vehicle in accordance with claim 1, wherein said abutting portion (31) of said inclination prevention bracket (30) is provided with a swing rack (314), and a roller (315) rotatably mounted on said swing rack (314) and rested on the ground.

6. The inclination prevention structure of a child wheeled vehicle in accordance with claim 1, wherein said abutting portion (31) of said inclination prevention bracket (30) is formed with an arc-shaped face (316) which can be rested on the ground.
